(19) United States
(12) Patent Application Publication
(10) Pub. No.: US 2006/0147737 A1
(43) Pub. Date: Jul. 6, 2006

(54) Reactive colorant compounds and polymeric materials copolymerized therewith

(76) Inventors: Jason Clay Pearson, Kingsport, TN (US); Greg Alan King, Mount Carmel, TN (US)

Correspondence Address: Eastman Chemical Company, P.O. Box 511, Kingsport, TN, 37662-5075, US

(21) Appl. No.: 11/283,339

(22) Filed: Nov. 18, 2005

Related U.S. Application Data
(60) Provisional application No. 60/629,404, filed on Nov. 22, 2004.

(51) Int. Cl. B32B 27/30; C09K 5/00; C09D 1/00; B05D 5/06

(52) U.S. Cl. 428/500; 524/556; 106/31.01

(57) ABSTRACT

Disclosed are certain polyoxyalkylene-containing colorant compounds having one or more ethylenically-unsaturated, photopolymerizable radicals that which may be copolymerized (or cured) with ethylenically-unsaturated monomers to produce colored compositions such as colored acrylic polymers. Suitable compositions having the present colorants copolymerized therein include, e.g., polymers produced from acrylate and methacrylate esters, colored polystyrenes, and similar colored polymeric materials derived from other ethylenically-unsaturated monomers. The ethylenically unsaturated colorant compounds may be suitable for use in coatings that are applied to wood, glass, metal, thermoplastics and the like.

This application claims the benefit of U.S. Provisional Application Ser. No. 60/629,404 filed Nov. 22, 2004.

### FIELD OF THE INVENTION

This invention pertains to certain novel colorant compounds that contain one or more polyoxyalkylene groups and one or more ethylenically-unsaturated (vinyl), photopolymerizable or free-radically polymerizable radicals. The colorant compounds may be copolymerized (or cured) with ethylenically-unsaturated monomers to produce colored compositions such as colored acrylic polymers, e.g., polymers produced from acrylate and methacrylate esters, colored polystyrenes, and similar colored polymeric materials derived from other ethylenically-unsaturated monomers. The novel colorant compounds possess good solubility in solvents and vinyl monomers. The ethylenically unsaturated colorant compounds may be suitable for use in coatings that are applied to paper, wood, glass, metal, leather, thermoplastics and the like.

### BACKGROUND

It is known (J.S.D.C., April 1977, pp 114-125) to produce colored polymeric materials by combining a reactive polymer such as polymers having epoxy groups or polyacryloyl chloride with anthraquinone dyes containing nucleophilic reactive groups such as amino or hydroxy groups; to graft acryloylaminoanthraquinone dyes to the backbone of vinyl or divinyl polymers; and to polymerize anthraquinone dyes containing certain olefinic groups to produce polymeric dyes/pigments. U.S. Pat. No. 4,115,056 describes the preparation of blue, substituted 1,4-diaminoanthraquinone dyes containing one acryloyloxy group and the use of the dyes in coloring various fibers, especially polyamide fibers. U.S. Pat. No. 4,943,617 discloses liquid crystalline copolymers containing certain blue, substituted 1,5-diamino-4,8-dihydroxyanthraquinone dyes containing an olefinic group copolymerized therein to provide liquid crystal copolymers having high dichromism. U.S. Pat. No. 5,055,602 describes the preparation of certain substituted 1,4-diaminoanthraquinone dyes containing polymerizable acryloyl and methacryloyl groups and their use in coloring polyacrylate contact lens materials by copolymerizing.

U.S. Pat. No. 5,362,812 discloses the conversion of a variety of dye classes into polymeric dyes by (a) polymerizing 2-alkenylazlactones and reacting the polymer with dyes containing nucleophilic groups and by (b) reacting a nucleophilic dye with an alkenylazalactone and then polymerizing the free radically polymerizable dyes thus produced. The polymeric dyes are reported to be useful for photoresist systems and for color proofing. U.S. Pat. No. 5,367,039 discloses a process for preparing colored vinyl polymers suitable for inks, paints, toners and the like by emulsion polymerization of a vinyl monomer with reactive anthraquinone dyes prepared by functionalizing certain anthraquinone dyes with methacryloyl groups.

The preparation of a variety of dyes that contain photopolymerizable groups and their use for color filters suitable for use in liquid crystal television sets, color copying machines, photosensitive resist resin compositions, and the like are described in U.S. Pat. No. 5,578,419. The preparation of a variety of anthraquinones dyes which contain photopolymerizable groups is disclosed in WO 02/12401 A2, WO 02/12402 A2 and WO 02/12403 A3.

### BRIEF DESCRIPTION OF THE INVENTION

The polyoxyalkylene, ethylenically-unsaturated colorants of the present invention have one or more of formulas I-VI: 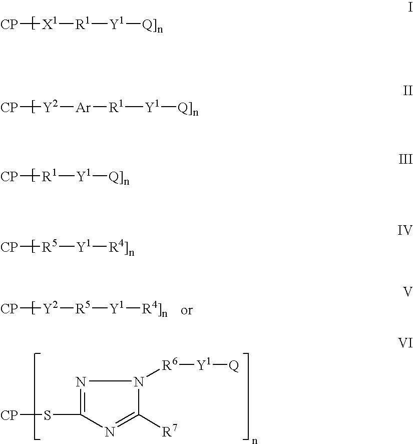
wherein

CP is a mono-, di-, tri- or tetravalent chromophore;

R¹ is —O—(CH₂CH(R²)O—)ₘ—CH₂CH(R²)—, —N(R³)—(CH₂CH(R²)O—)ₘ—CH₂CH(R²)— or —N[(CH₂CH(R²)O—)ₘ—CH₂CH(R²)—]₂;

R² is hydrogen or C₁-C₆ alkyl

R³ is hydrogen, C₁-C₆-alkyl, aryl or C₃-C₈-cycloalkyl;

R⁴ is —(CH₂CH(R²)O—)ₘ-Q;

R⁵ is C₁-C₆-alkylene, C₁-C₆-alkylene-arylene, cyclohexylene, arylene, C₁-C₆-alkylene-cyclohexylene or C₁-C₆-alkylene-cyclohexylene-C₁-C₆-alkylene;

R⁶ is —(CH₂CH(R²)O—)ₘ—CH₂CH₂—;

R⁷ is hydrogen, C₁-C₆-alkyl, aryl or C₃-C₈-cycloalkyl;

X¹ is —CO—, —SO₂— or arylene;

Y¹ is —O—, —N(R³)—, —N(R⁴)— or —S—;

Y² is —O—, —S—, —SO₂— or —N(R³)— or —N(R⁴)—;

Ar is arylene;

m is 4 to 100;

n is 1 to 4; and

Q is a photopolymerizable group selected from an organic radical having the formulae: 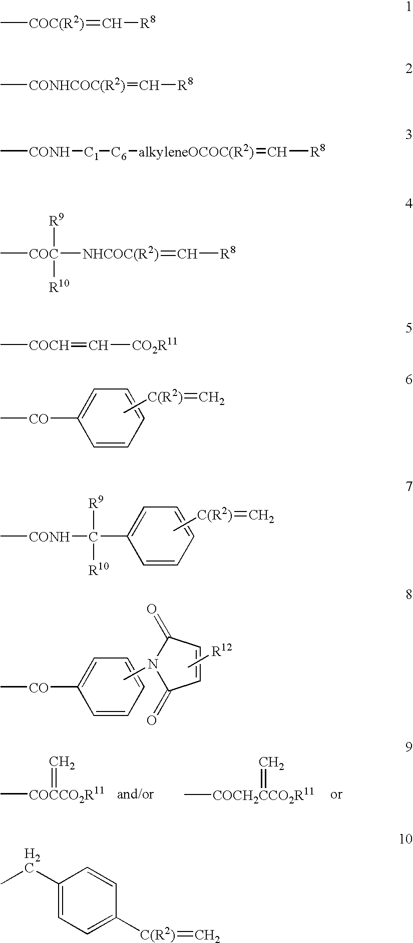
wherein

R² is hydrogen or C₁-C₆-alkyl;

R⁸ is hydrogen; C₁-C₆-alkyl; phenyl; phenyl substituted with one or more groups selected from C₁-C₆-alkyl, C₁-C₆-alkoxy, —N(C₁-C₆-alkyl)₂, nitro, cyano, C₂-C₆-alkoxycarbonyl, C₂-C₆-alkanoyloxy, and halogen; 1- or 2-naphthyl; 1- or 2-naphthyl substituted with C₁-C₆-alkyl or C₁-C₆-alkoxy; 2- or 3-thienyl; 2- or 3-thienyl substituted with C₁-C₆-alkyl or halogen; 2- or 3-furyl; or 2- or 3-furyl substituted with C₁-C₆-alkyl;

R⁹ and R¹⁰ individually are the same or different and are hydrogen, C₁-C₆-alkyl, aryl; or in combination R⁹ and R¹⁰ represent a divalent -(—CH₂—)₃₋₅-radical;

R¹¹ is hydrogen, C₁-C₆-alkyl, C₃-C₈-alkenyl, C₃-C₈-cycloalkyl or aryl; and

R¹² is hydrogen, C₁-C₆-alkyl or aryl.

For the groups identified herein as any of R¹ through R¹⁵, Q, X¹, Y¹, Y², or Ar, it will be understood that throughout this application each occurrence of such groups in one or more series of repeating structures (e.g. designated by subscripts ₙ and ₘ) can be identical structures (e.g. all the same R¹ group) in some embodiments and can be different structures (e.g. several different R¹ groups) in some embodiments. The present invention provides economical, photopolymerizable colorants with improved solubility in solvents or monomers relative to that known in the art. Preferably, the ethylenically-unsaturated colorants of the present invention are liquids. The improvement in solubility prevents precipitation of the ethylenically-unsaturated colorant molecules from solvents and ethylenically unsaturated monomers, which aides in the handling and processing of the colorant molecules.

A second embodiment of the present invention pertains to a coating composition comprising (i) one or more polymerizable vinyl compounds, (ii) one or more of the colorant compounds having one or more of Formulas I-VI described above, and (iii) a photoinitiator.

A third embodiment of the present invention pertains to a polymeric composition, typically a coating, comprising a polymer of one or more acrylic acid esters, one or more methacrylic acid esters, styrenes and/or other polymerizable vinyl compounds, having copolymerized therein one or more of the colorant compounds having one or more of Formulas I-VI described above.

A fourth embodiment of the present invention pertains to articles coated with the polymeric composition, such as metal, glass, wood, paper, leather, thermoplastics and the like, comprising a polymer of one or more acrylic acid esters, one or more methacrylic acid esters, styrenes and/or other polymerizable vinyl compounds, having copolymerized therein one or more of the colorant compounds having one or more of Formulas I-VI described above.

A fifth embodiment of the present invention pertains to inks that contain colorant compounds having one or more of Formulas I-VI.

The ethylenically unsaturated colorants of the present invention are characterized by three primary components: (1) an organic chromophore having (2) a polyoxyalkylene substituent having (3) an ethylenically-unsaturated group that is capable of undergoing free radical polymerization with ethylenically-unsaturated moieties, such as acrylate esters, styrenes, methacrylate esters, acrylic acid, methacrylic acid and other suitable monomers. The ethylenically unsaturated group is not an endocyclic C═C double bond in an aromatic ring. The polyoxyalkylene substituent typically is a polymeric group resulting from the reaction and polymerization of ethylene oxide, propylene oxide or a combination thereof with a nucleophillic group, e.g., hydroxyl and amino, present on a chromophore (or a chromophore prescursor) from which the compounds of the invention are derived. Random and block copolymers of ethylene oxide and propylene oxide also are suitable. Some or all of the polyoxyalkylene substituents having the formula —(CH₂CH(R′)O—)ₘ—CH₂CH₂— may be terminated with a hydroxy or alkyl group. The ethylenically unsaturated colorant compounds may be used in coatings for application to paper, wood, glass, metal, leather, thermoplastics and the like.

### DETAILED DESCRIPTION

In formulas I-VI, CP represents a mono-, di-, tri- or tetra-valent residue of a chromophore, i.e., a compound that absorbs electromagnetic radiation in the region from about 300 nm to about 900 nm. Examples of the chromophoric residues which CP may represent include anthraquinone, anthrapyridone (3H-dibenz-[f,ij]-isoquinoline-2,7-dione, anthrapyrim idine (7H-dibenz-[f,ij]-isoquinoline-7-one), anthrapyrimidine (7H-benzo[e]-perimidine-7-one), anthrapyrimidone, isothiazoloanthrone, azo, bis-azo, methine, bis-methine, coumarin (2-H-1-benzopyran-2-one), 3-aryl-2,5-dioxypyrroline, 3-aryl-5-dicyanomethylene-2-oxypyrroline, perinone, quinophthalone, phthalocyanine, metal phthalocyanine, indanthrone, pyrylium, nitroarylamine or a 2,5-diarylaminoterephthalic ester chromophore.

Some commercial examples of polyoxyalkylene-containing colorants that may be used in the synthesis of the colorants of the present invention include compounds sold under the trade names Versatint™ and Reactint™. Polyoxyalkylene-functional colorants having a molecular weight range from about 400 to about 800, typical of Reactint™ dyes, are preferred since these colorants typically are liquids and the color strength is high relative to polyoxyalkylene colorants that have a molecular weight range from about 2000 to about 3000, which is typical for the Versatint™ dyes. The structures of several representative examples of these dyes are disclosed in Developments in the Chemistry and Technology of Organic Dyes, Volume 7 J. Griffiths,©1984, Belgrave Square, London. Synthesis of organic chromophores containing polyoxyalkylene substituents are disclosed in U.S. Pat. Nos. 3,157,633, 4,167,510, 4,284,729 and 4,732,570.

The ethylenically unsaturated colorants of Formulas I-VI are prepared by reacting polyoxyalkylene substituted organic chromophores with at least one of the acylating or alkylating agents of formulas 1′=10′: 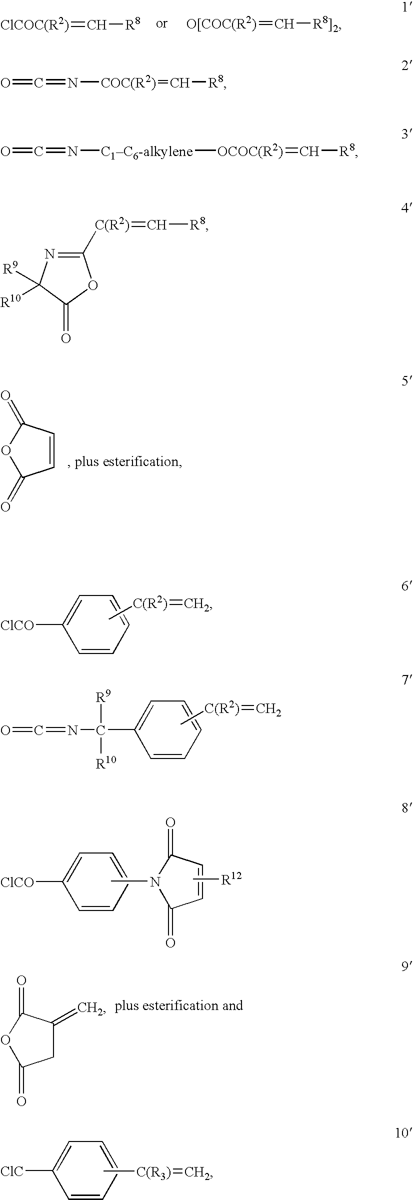
wherein R³, R⁴, R⁵, R⁶ and R⁸ are as defined previously. When using anhydrides 5′ and 9′, the acylated colorant compound initially obtained contains a carboxy group that is esterified, e.g., by reaction with an alcohol such as a C₁-C₆ alkanol. Q preferably is a group having the formula —COC(R³)═CH₂ or 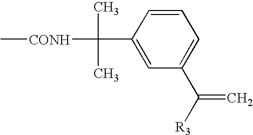
wherein R₃ is hydrogen or methyl.

The term “C₁-C₆-alkyl” is used to denote a straight- or branched-chain, saturated, aliphatic hydrocarbon radical containing one to six carbon atoms. The term “substituted C₁-C₆-alkyl” is used to denote a straight- or branched-chain, saturated, aliphatic hydrocarbon radical containing one to six carbon atoms substituted with one or more groups, preferably one to three groups, selected from the group consisting of hydroxy, halogen, cyano, aryl, aryloxy, arylthio, C₁-C₆-alkylthio, C₃-C₈-cycloalkyl, C₂-C₆-alkanoyloxy and -(—O—R⁹—)ₚ—R¹⁰ wherein R⁹ is selected from the group consisting of C₁-C₆-alkylene, C₁-C₆-alkylene-arylene, cyclohexylene, arylene, C₁-C₆-alkylene-cyclohexylene and C₁-C₆-alkylene-cyclohexylene-C₁-C₆-alkylene, R¹⁰ is selected from the group consisting of hydrogen, hydroxy, carboxy, C₂-C₆-alkanoyloxy, C₂-C₆-alkoxycarbonyl, aryl and C₃-C₈-cycloalkyl; and p is 1, 2, or 3.

The terms “C₁-C₆-alkylene is used to denote straight- or branched-chain, divalent, aliphatic hydrocarbon radicals containing one to six carbons. These divalent radicals may be substituted with one to three groups selected from C₁-C₆-alkoxy, C₂-C₆-alkoxycarbonyl, C₂-C₆-alkanoyloxy, hydroxy, aryl and halogen. The term “C₃-C₈-alkenyl” is used to denote an aliphatic hydrocarbon radical containing at least one double bond. The term “C₃-C₈-cycloalkyl” is used to denote a saturated, carbocyclic, hydrocarbon radical having three to eight carbon atoms optionally substituted with one to three C₁-C₆-alkyl group(s).

The term “aryl” as used herein denotes phenyl and phenyl substituted with one to three substituents selected from C₁-C₆-alkyl, substituted C₁-C₆-alkyl, C₁-C₆-alkoxy, halogen, carboxy, cyano, C₂-C₆-alkanoyloxy, C₁-C₆-alkylthio, C₁-C₆-alkylsulfonyl, trifluoromethyl, hydroxy, optionally substituted sulfamoyl, C₂-C₆-alkoxycarbonyl, C₂-C₆-alkanoylamino and —O—R³, S—R³, —SO₂—R¹³, —NHSO₂R¹³ and —NHCO₂R¹³, wherein R¹³ is phenyl or phenyl substituted with one to three groups selected from C₁-C₆-alkyl, C₁-C₆-alkoxy and halogen. The term “arylene” as used herein denotes includes 1,2-, 1,3- and 1,4-phenylene and such divalent radicals substituted with one to three groups selected from C₁-C₆-alkyl, C₁-C₆-alkoxy and halogen.

The term “halogen” is used to include fluorine, chlorine, bromine, and iodine. The term “optionally substituted sulfamoyl” is used to describe the group having the structure —SO₂N(R¹⁴)R¹⁵, wherein R¹⁴ and R¹⁵ are independently selected from hydrogen, C₁-C₆-alkyl, substituted C₁-C₆-alkyl, C₃-C₈-alkenyl, C₃-C₈-cycloalkyl, aryl and heteroaryl. The terms “C₁-C₆-alkoxy”, “C₂-C₆-alkoxycarbonyl”, “C₂-C₆-alkanoyl”, “C₂-C₆-alkanoyloxy”, “C₂-C₆-alkanoylamino”, “C₁-C₆-alkylthio” and “C₁-C₆-alkylsulfonyl” are used to denote radicals corresponding to the structures —OR¹⁵, —CO₂R¹⁵, —COR¹⁵, —OCOR¹⁵, NHCOR¹⁵, —SR¹⁵ and —SO₂R¹⁵ respectively, wherein R¹⁵ is C₁-C₆-alkyl or substituted C₁-C₆-alkyl.

The term “heteroaryl” as used herein denotes a 5- or 6-membered aromatic ring containing one to three hetero atom selected from oxygen, sulfur and nitrogen. Examples of such heteroaryl groups are thienyl, furyl, pyrrolyl, imidazolyl, pyrazolyl, thiazolyl, isothiazolyl, oxazolyl, isoxazolyl, triazolyl, thiadiazolyl, oxadiazolyl, tetrazolyl, pyridyl, pyrimidyl, benzoxazolyl, benothiazolyl, benzimidazolyl, indolyl and the like and these optionally substituted with one to three groups selected from C₁-C₆-alkyl, C₁-C₆-alkoxy, substituted C₁-C₆-alkyl, halogen, C₁-C₆-alkylthio, aryl, arylthio, aryloxy, C₂-C₆-alkoxycarbonyl and C₂-C₆-alkanoylamino.

The phrase “ethylenically-unsaturated photopolymerizable group” or “free radical initiated polymerizable group” will be understood to the person of skill in the art to refer to a moiety having a reactive C═C double bond, including those having a vinyl group; preferably, the reactive double bond is activated by being attached to an aryl group or an electron withdrawing group such as a carbonyl. The phrase “reactive C═C double bonds” does not include the endocyclic conjugated double bonds in an aromatic ring since these bonds are know to be unreactive to free radical polymerization under normal polymerization conditions.

The skilled artisan will understand that each of the references herein to groups or moieties having a stated range of carbon atoms, such as “C₁-C₆-alkyl,” includes not only the C, group (methyl) and C₆ group (hexyl) end points, but also each of the corresponding individual C₂, C₃, C₄ and C₅ groups. In addition, it will be understood that each of the individual points within a stated range of carbon atoms may be further combined to describe subranges that are inherently within the stated overall range. For example, the term “C₁-C₆-alkyl” includes not only the individual moieties C₁ through C₆, but also contemplates subranges such as “C₂-C₅-alkyl.”

In some embodiments, the functionalized dyes or colorants which contain vinyl or substituted vinyl groups are polymerizable or copolymerizable, preferably by free radical mechanisms, said free radicals being generated by exposure to UV light by methods known in the art of preparing UV-cured resins. Polymerization can be facilitated by the addition of photoinitiators. The colored polymeric materials normally are prepared by dissolving the functionalized colorants containing copolymerizable groups in a polymerizable vinyl monomer with or without another solvent and then combining with an oligomeric or polymeric material which contains one or more vinyl or substituted vinyl groups.

The polymerizable vinyl compounds useful in the present invention contain at least one unsaturated group capable of undergoing polymerization upon exposure to UV radiation in the presence of a photoinitiator, i.e., the coating compositions are radiation-curable. Examples of such polymerizable vinyl compounds include acrylic acid, methacrylic acid and their anhydrides; crotonic acid; itaconic acid and its anhydride; cyanoacrylic acid and its esters; esters of acrylic and methacrylic acids such as allyl, methyl, ethyl, n-propyl, isopropyl, butyl, tetrahydrofurfuryl, cyclohexyl, isobornyl, n-hexyl, n-octyl, isooctyl, 2-ethylhexyl, lauryl, stearyl, and benzyl acrylate and methacrylate; and diacrylate and dimethacrylate esters of ethylene and propylene glycols, 1,3-butylene glycol, 1,4-butanediol, diethylene and dipropylene glycols, triethylene and tripropylene glycols, 1,6-hexanediol, neopentyl glycol, polyethylene glycol, and polypropylene glycol, ethoxylated bisphenol A, ethoxylated and propoxylated neopentyl glycol; triacrylate and trimethacrylate esters of tris-(2-hydroxyethyl)isocyanurate, trimethylolpropane, ethoxylated and propoxylated trimethylolpropane, pentaerythritol, glycerol, ethoxylated and propoxylated glycerol; tetraacrylate and tetramethacrylate esters of pentaerythritol and ethoxylated and propoxylated pentaerythritol; acrylonitrile; vinyl acetate; vinyl toluene; styrene; N-vinyl pyrrolidinone; alpha-methylstyrene; maleate/fumarate esters; maleic/fumaric acid; crotonate esters, and crotonic acid.

The polymerizable vinyl compounds useful in the present invention include polymers which contain unsaturated groups capable of undergoing polymerization upon exposure to UV radiation in the presence of a photoinitiator. The preparation and application of these polymerizable vinyl compounds are well known to those skilled in the art as described, for example, in Chemistry and Technology of UV and EB Formulation for Coatings, Inks, and Paints, Volume II: Prepolymers and Reactive Diluents, G. Webster, editor, John Wiley and Sons, London, 1997. Examples of such polymeric, polymerizable vinyl compounds include acrylated and methacrylated polyesters, acrylated and methacrylated polyethers, acrylated and methacrylated epoxy polymers, acrylated or methacrylated urethanes, acrylated or methacrylated polyacrylates (polymethacrylates), and unsaturated polyesters. The acrylated or methacrylated polymers and oligomers typically are combined with monomers which contain one or more acrylate or methacrylate groups, e.g., monomeric acrylate and methacrylate esters, and serve as reactive diluents. The unsaturated polyesters, which are prepared by standard polycondensation techniques known in the art, are most often combined with either styrene or other monomers, which contain one or more acrylate or methacrylate groups and serve as reactive diluents. Another embodiment for the utilization of unsaturated polyesters that is known to the art involves the combination of the unsaturated polyester with monomers that contain two or more vinyl ether groups or two or more vinyl ester groups (WO 96/01283, WO 97/48744, and EP 0 322 808).

The coating compositions of the present invention optionally may contain one or more added organic solvents. Examples of suitable solvents include, but are not limited to aromatics, ketones, alcohols, esters, chlorinated hydrocarbons, glycol ethers, glycol esters, and mixtures thereof. Specific examples include, but are not limited to acetone, 2-butanone, 2-pentanone, ethyl acetate, propyl acetate, isopropyl acetate, butyl acetate, isobutyl acetate, ethylene glycol diacetate, ethyl 3-ethoxypropionate, methyl alcohol, ethyl alcohol, propyl alcohol, isopropyl alcohol, butyl alcohol, ethylene glycol, propylene glycol, ethylene glycol monomethyl ether, ethylene glycol monoethyl ether, ethylene glycol monopropyl ether, ethylene glycol monobutyl glycol, diethylene glycol monomethyl ether, diethylene glycol monoethyl ether, diethylene glycol monobutyl ether, propylene glycol monomethyl ether, diethylene glycol monobutyl ether acetate, diethylene glycol monoethyl ether acetate, ethylene glycol monobutyl ether acetate, propylene glycol monomethyl ether acetate, methylene chloride, chloroform, toluene, xylene and mixtures thereof. Preferred mixtures of solvents may include esters, ketones and aromatic solvents such as toluene, xylene, acetone, 2-pentanone ethyl acetate and the like. The amount of added or extraneous solvent which may be present in our novel coating compositions may be in the range of about 1 to 40 weight percent, more typically about 1 to 25 weight percent, based on the total weight of the coating composition.

Certain polymerizable vinyl monomers may serve as both reactant and solvent. These contain at least one unsaturated group capable of undergoing polymerization upon exposure to UV radiation in the presence of a photoinitiator. Specific examples include, but are not limited to: methacrylic acid, acrylic acid, ethyl acrylate and methacrylate, methyl acrylate and methacrylate, hydroxyethyl acrylate and methacrylate, diethylene glycol diacrylate, trimethylolpropane triacrylate, 1,6 hexanediol di(meth)acrylate, neopentyl glycol diacrylate and methacrylate, vinyl ethers, divinyl ethers such as diethyleneglycol divinyl ether, 1,6-hexanediol divinyl ether, cyclohexanedimethanol divinyl ether, 1,4-butanediol divinyl ether, triethyleneglycol divinyl ether, trimethylolpropane divinyl ether, and neopentyl glycol divinyl ether, vinyl esters, divinyl esters such as divinyl adipate, divinyl succinate, divinyl glutarate, divinyl 1,4-cyclohexanedicarboxylate, divinyl 1,3-cyclohexanedicarboxylate, divinyl isophthalate, and divinyl terephthalate, N-vinyl pyrrolidone, and mixtures thereof.

In addition, the compositions of the present invention may be dispersed in water rather than dissolved in a solvent to facilitate application and coating of the substrate surface. In the water-dispersed compositions of the present invention a co-solvent is optionally used. Typical examples of suitable cosolvents include but are not limited to acetone, 2-butanone, methanol, ethanol, isopropyl alcohol, ethylene glycol monomethyl ether, ethylene glycol monoethyl ether, ethylene glycol monopropyl ether, and ethylene glycol monobutyl ether, ethylene glycol, and propylene glycol. Typical examples of water-soluble ethylenically unsaturated solvents include but are not limited to: methacrylic acid, acrylic acid, N-vinyl pyrrolidone, 2-ethoxyethyl acrylate and methacrylate, polyethylene glycol dimethacrylate, polypropylene glycol monoacrylate and monomethacrylate, and mixtures thereof. The amount of suitable aqueous organic solvent (i.e., organic solvent and water) in the dispersed coating compositions of the present invention is about 10 to about 90 weight percent, preferably about 75 to about 90 weight percent of the total coating composition.

The coating compositions of the present invention contain one or more of the ethylenically-unsaturated colorant compounds described herein. The concentration of the ethylenically-unsaturated colorant compound or compounds may be from about 0.005 to about 40.0 weight percent but is preferably from about 0.5 to about 30, weight percent based on the weight of the polymerizable vinyl compound(s) present in the coating composition, i.e., component (i) of the coating compositions.

The coating compositions of the present invention normally contain a photoinitiator. The amount of photoinitiator typically is about 1 to 15 weight percent, preferably about 3 to about 5 weight percent, based on the weight of the polymerizable vinyl compound(s) present in the coating composition. Typical photoinitiators include benzoin and benzoin ethers such as marketed under the tradenames ESACURE BO, EB1, EB3, and EB4 from Fratelli Lamberti; VICURE 10 and 30 from Stauffer; benzil ketals such as 2,2-dimethoxy-1,2-diphenylethan-1-one (IRGACURE 651), 2-hydroxy-2-methyl-1-phenylpropan-1-one (IRGACURE 1173), 2-methyl-2-morpholino-1-(p-methylthiophenyl)propan-1-one (IRGACURE 907), alpha-hydroxyalkylphenones such as (1-hydroxycyclohexyl)(phenyl)methanone (IRGACURE 184), 2-benzyl-2-(dimethylamino)-1-(4-morpholinophenyl)butan-1-one (IRGACURE 369), 2-hydroxy-2-methyl-1-phenylpropan-1-one (IRGACURE 1173) from Ciba Geigy, Uvatone 8302 by Upjohn; alpha, alpha-dialkoxyacetophenone derivatives such as DEAP and UVATONE 8301 from Upjohn; DAROCUR 116, 1173, and 2959 by Merck; and mixtures of benzophenone and tertiary amines In pigmented coating compositions, the rate of cure can be improved by the addition of a variety of phosphine oxide photoinitiaters such as bis(2,4,6-trimethylbenzoyl)-phenylphosphine oxide (IRGANOX 819), IRGACURE 819, 1700, and 1700 and phosphine oxide mixtures such as a 50/50 by weight mixtures of IRGACURE 1173 and 2,4,6-trimethylbenzoyldiphenylphosphine oxide (DAROCUR 4265) from Ciba. Further details regarding such photoinitiators and curing procedures may be found in the published literature such as U.S. Pat. No. 5,109,097, incorporated herein by reference. Depending upon the thickness of the coating (film), product formulation, photoinitiator type, radiation flux, and source of radiation, exposure times to ultraviolet radiation of about 0.5 second to about 30 minutes (50-5000 mJ/square cm) typically are required for curing. Curing also can occur from solar radiation, i.e., sunshine.

The coating compositions of the present invention may contain one or more additional components typically present in coating compositions. Examples of such additional components include leveling, rheology, and flow control agents such as silicones, fluorocarbons or cellulosics; flatting agents; pigment wetting and dispersing agents; surfactants; ultraviolet (UV) absorbers; UV light stabilizers; tinting pigments; defoaming and antifoaming agents; anti-settling, anti-sag and bodying agents; anti-skinning agents; anti-flooding and anti-floating agents; fungicides and mildewcides; corrosion inhibitors; thickening agents; and/or coalescing agents. The coating compositions of the present invention also may contain non-reactive modifying resins. Typical non-reactive modifying resins include homopolymers and copolymers of acrylic and methacrylic acid; homopolymers and copolymers of alkyl esters of acrylic and methacrylic acid such as methyl, ethyl, n-propyl, isopropyl, butyl, tetrahydro-furfuryl, cyclohexyl, isobornyl, n-hexyl, n-octyl, isooctyl, 2-ethylhexyl, lauryl, stearyl, and benzyl acrylate and methacrylate; acrylated and methacrylated urethane, epoxy, and polyester resins, silicone acrylates, cellulose esters such as cellulose acetate butyrates, cellulose acetate, propionates, nitrocellulose, cellulose ethers such as methyl cellulose, ethyl cellulose, hydroxypropyl cellulose, and hydroxypropyl methyl cellulose.

Examples of plasticizers include alkyl esters of phthalic acid such as dimethyl phthalate, diethyl phthalate, dipropyl phthalate, dibutyl phthalate, and dioctyl phthalate; citrate esters such as triethyl citrate and tributyl citrate; triacetin and tripropionin; and glycerol monoesters such as Eastman 18-04, Eastman 18-07, Eastman 18-92 and Eastman 18-99 from Eastman Chemical Company. Specific examples of additional additives can be found in Raw Materials Index, published by the National Paint & Coatings Association, 1500 Rhode Island Avenue, N.W., Washington, D.C. 20005.

As disclosed herein, the coating compositions of the present invention may be prepared as a result of a free radical cure process but the method by which cure occurs is not a limiting aspect of the invention. One skilled in the art appreciates that UV-light, electron beam and free radical initiators such as peroxides and related compounds that decompose to give species that can initiate polymerization of ethylenically-unsaturated monomers and the colorants of the present invention.

The polymeric coatings of the present invention typically have a solvent resistance of at least 200 MEK double rubs using ASTM Procedure D-3732; preferably a solvent resistance of at least about 300 double rubs. Such coatings also typically have a pencil hardness of greater than or equal to F using ASTM Procedure D-3363; preferably a pencil hardness of greater than or equal to H. The coating compositions can be applied to substrates with conventional coating equipment. The coated substrates are then exposed to radiation such as ultraviolet light in air or in nitrogen, which gives a cured finish. Mercury vapor or Xenon lamps are applicable for the curing process. The coatings of the present invention can also be cured by electron beam.

The radiation-curable coating compositions of this invention are suitable as adhesives and coatings for such substrates as metals such as aluminum and steel, plastics, glass, wood, paper, and leather. On wood substrates the coating compositions may provide both overall transparent color and grain definition. Various aesthetically-appealing effects can be achieved thereby. Due to reduced grain raising and higher film thicknesses, the number of necessary sanding steps in producing a finished wood coating may be reduced when using the colored coating compositions of the invention rather than conventional stains. Coating compositions within the scope of our invention may be applied to automotive base coats where they can provide various aesthetically-appealing effects in combination with the base coats and color differences dependent on viewing angle (lower angles create longer path lengths and thus higher observed color intensities). This may provide similar styling effects as currently are achieved with metal flake orientation in base coats. Coating compositions within the scope of our invention may be applied to window films that may be suitable for automotive and architectural applications. Coating compositions within the scope of our invention may be applied to glass such as a fiber optic cable.

Various additional pigments, plasticizers, and stabilizers may be incorporated to obtain certain desired characteristics in the finished products. These are included in the scope of the invention.

### EXAMPLES

The novel colorant compounds provided by the present invention are further illustrated by the following examples. The precise chemical identity of each of the commercial dyes employed in the examples was not determined. Thus, the examples illustrate a variety of chromophores comprising a polyoxyalkylene moiety and an ethylenically-unsaturated group. All percentages given in the examples are by weight unless specified otherwise. The following colorant compounds used as reactants in the examples were obtained from Milliken & Company:

Reactant I: REACTINT Orange X96—LOT Q1888

Reactant II: REACTINT Red X64—LOT S1202

Reactant III: REACTINT Blue X17AB—LOT: S1024

Reactant IV: REACTINT Yellow X15—LOT: S5345

### Example 1

Reactant I (6.37 g) and 30 g of toluene were added to a 100 mL round-bottomed flask equipped with a magnetic stir bar, heating mantle and Dean Stark trap. The homogeneous solution was heated to reflux to remove any water that may have been present. The solution was allowed to cool to about 50° C.; then methacrylic anhydride (7.1 mL), triethylamine (6.7 mL), 4-dimethylaminopyridine (DMAP, 97 mg) and hydroquinone (63 mg) were added. The reaction mixture was heated to 95° C. and stirred for 20 minutes. Silica gel thin layer chromatography (TLC) was employed to follow the reaction progression (TLC solvent=5% methanol in methylene chloride; R_{f} Reactant I=0.25; R_{f} methacrylated product=0.30). The reaction solution was allowed to cool to room temperature and stirred overnight; then transferred to a separatory funnel and washed, in order, with 100 mL of 0.5 M acetic acid, 100 mL of 5% sodium bicarbonate solution and 100 mL of water. The toluene solution was transferred to a 100 mL round bottomed flask equipped with a magnetic stir bar, heating mantle and Dean Stark trap then refluxed until all water had been removed (about 30 mL of water was collected). TLC analysis (5% methanol in methylene chloride) revealed that the methacrylate functionalized compound was not hydrolyzed during the work-up process. The remaining toluene solution had a mass of 24.28 g. A small sample (2 g) of the toluene solution was transferred to a 50 mL flask and concentrated to remove the toluene using a rotary evaporator to give 0.56 g of a thick liquid dye, which correspond to a concentration of 28% of the methacrylate derivative of Reactant I in toluene. High performance liquid chromatography mass spectral analysis (HPLC MS) confirmed the presence of the methacrylate derivative of Reactant I.

Reactant I was a mixture that had several components that gave rise to peaks with molecular weights between about 567 and about 928 atomic mass units (amu). The methacrylate derivative was a mixture that had several components that gave rise to peaks with molecular weights between about 662 and about 950 atomic mass units (amu). A dimethylformamide (DMF) solution of Reactant I and the methacrylate derivatives had wavelengths of maximum absorbance (λₘₐₓ) at 482.9 nm in DMF. The molar extinction coefficient (ε) of the methacrylate derivative of Reactant I was estimated to be 9,892 based upon an average molecular weight of 765 g/mol.

### Example 2

Reactant II (7.09 g), methacrylic anhydride (7.1 mL), triethylamine (6.7 mL), DMAP (97 mg), hydroquinone (63 mg) and 30 g of toluene were added to a 100 mL round-bottom flask equipped with a magnetic stir bar. The reaction solution was stirred at room temperature for about 15 hours. Silica gel thin layer chromatography (TLC) was employed to follow the reaction progression (TLC solvent=10% methanol in methylene chloride; R_{f} Reactant II=0.35; R_{f} methacrylated product=0.41) and complete conversion had occurred with about 3.5 h. The reaction solution was transferred to a separatory funnel and washed, in order, with 100 mL of 0.5 M acetic acid, 100 mL of 5 wt % sodium bicarbonate solution and 100 mL of brine solution. The brine wash resulted in the formation of an emulsion that did not readily separate. The emulsion was diluted with 300 mL of toluene and 500 mL of water, shaken and allowed to stand for about 24 hours, at which time two distinct layers had formed. The toluene layer was removed and concentrated using a rotary evaporator until about 300 mL of distillate had been removed to give 18.55 g of the methacrylate derivative of Reactant II as a solution in toluene. TLC analysis (10 wt % methanol in methylene chloride) revealed that the methacrylate functional dye was not hydrolyzed during the work-up process. A small sample (2 g) of the toluene solution was transferred to a 50 mL flask and concentrated to remove the toluene using a rotary evaporator to give 0.64 g of a thick liquid dye, which correspond to a concentration of 32 wt % of the methacrylate derivative of Reactant II in toluene. High performance liquid chromatography mass spectral analysis (HPLC MS) confirmed the presence of the methacrylate derivative of Reactant II.

Reactant II was a mixture that had several components that gave rise to peaks with molecular weights between about 411 and about 950 atomic mass units (amu). The methacrylate derivative was a mixture that had several components that gave rise to peaks with molecular weights between about 509 and about 971 atomic mass units (amu). A DMF solution of Reactant II and the methacrylate derivatives had wavelengths of maximum absorbance (λₘₐₓ) at 523.0 nm and 524 nm, respectively. The molar extinction coefficient (ε) of the methacrylate derivative of Reactant II was estimated to be 7,389 based upon an average molecular weight of 650 g/mol.

### Example 3

Reactant III (6.50 g), methacrylic anhydride (7.1 mL), triethylamine (6.7 mL), DMAP (97 mg), hydroquinone (63 mg) and 30 g of toluene were added to a 100 mL round-bottom flask equipped with a magnetic stir bar. The reaction solution was stirred at room temperature for about 15 hours. Silica gel thin layer chromatography (TLC) was employed to follow the reaction progression (TLC solvent=10% methanol in methylene chloride; R_{f} Reactant III=0.37; R_{f} methacrylated product=0.43) and complete conversion had occurred with about 3.5 hours. Toluene (100 mL) was added to the reaction solution and the resulting solution was transferred to a separatory funnel and washed, in order, with 100 mL of 0.5 M acetic acid, 100 mL of 5 wt % sodium bicarbonate solution and 100 mL of water. The toluene solution was transferred to a 250 mL round-bottomed flask equipped with a magnetic stir bar, heating mantle and distillation head then boiled until about 100 mL of distillate had been removed (about 3 mL of water was collected). The remaining toluene solution comprising the methacrylate derivatives of Reactant III had a mass of 14.75 g. TLC analysis (10% methanol in methylene chloride) revealed that the methacrylate functional dye was not hydrolyzed during the work-up process. A small sample (2 g) of the toluene solution was transferred to a 50 mL flask and concentrated to remove the toluene using a rotary evaporator to give 0.75 g of a thick liquid colorant which corresponds to a concentration of 37.5% of the methacrylate derivative of Reactant III in toluene. High performance liquid chromatography mass spectral analysis (HPLC MS) confirmed the presence of the methacrylate derivative of Reactant III. Reactant III was a mixture of several components that gave rise to major peaks with molecular weights of 530, 598 and 746 atomic mass units (amu).

The methacrylate derivative was a mixture that had several components that gave rise to major peaks with molecular weights of 598 (530+C(O)C(CH₃)═CH₂—Hydrogen) and 666 (598+C(O)C(CH₃)═CH₂—Hydrogen) atomic mass units (amu). A DMF solution of Reactant III and the methacrylate derivatives had wavelengths of maximum absorbance (λₘₐₓ) at 643.0 nm and 643.4 nm, respectively. The molar extinction coefficient (ε) of the methacrylate derivative of Reactant III was estimated to be 7,172 based upon an average molecular weight of 666 g/mol.

### Example 4

Reactant IV (7.17 g), methacrylic anhydride (7.1 mL), triethylamine (6.7 mL), DMAP (97 mg), hydroquinone (63 mg) and 30 g of toluene were added to a 100 mL round bottomed flask equipped with a magnetic stir bar. The reaction solution was stirred at room temperature for about 15 hours. The reaction solution was transferred to a separatory funnel and washed with 100 mL of 0.5 M acetic acid and 100 mL of 5% sodium bicarbonate. The sodium bicarbonate wash resulted in the formation of an emulsion that did not readily separate. The emulsion was diluted with 300 mL of toluene and 500 mL of water, shaken and allowed to stand for about 24 hours at which time two distinct layers had formed. The toluene layer was removed and concentrated using a rotary evaporator until about 300 mL of distillate had been removed to give 24.04 g of the methacrylate derivative of Reactant IV as a solution in toluene. A small sample (2 g) of the toluene solution was transferred to a 50 mL flask and concentrated to remove the toluene using a rotary evaporator to give 0.21 g of a thick liquid dye, which correspond to a concentration of 10.5% of the methacrylate derivative of Reactant IV in toluene. High performance liquid chromatography mass spectral analysis (HPLC MS) confirmed the presence of the methacrylate derivative of Reactant IV.

Reactant IV was a mixture that had several components that gave rise to peaks with molecular weights between about 480 and about 803 atomic mass units (amu). The methacrylate derivative was a mixture that had several components that gave rise to peaks with molecular weights between about 548 and about 871 atomic mass units (amu). DMF solutions of Reactant IV and the methacrylate derivatives had wavelengths of maximum absorbance (λₘₐₓ) at 428.7 nm and 428.5 nm, respectively. The molar extinction coefficient (ε) of the methacrylate derivative of Reactant IV was estimated to be 15,949 based upon an average molecular weight of 703 g/mol.

### Examples 5-8

The coatings and coating compositions provided by the present invention and the preparation thereof are further illustrated by the following examples. The photopolymerizable coating compositions of Examples 5-8 and Comparative Examples 1-5 were prepared by mixing the following ingredients while heating using a heat gun to about 60° C. until the color was uniform.
4.0 g polyester acrylate (Jägalux UV1500, Jäger);
8.0 g bisphenol A epoxy acrylate (Sartomer CN-104, Sartomer Company, Lot: E628);
3.6 g dipropyleneglycol diacrylate (DPGDA, Surface Specialties UCB);
3.2 g trimethylolpropane triacrylate (TMPTA-N, Surface Specialties UCB),
1.0 g photoinitiator (Darocurel 173, Ciba Specialty Chemicals Inc., Lot: DC02442R); and

1 weight percent, based on the total weight of all components, of one of the colorant compounds produced in Examples 1-4 or Reactants I-IV. A photopolymerizable coating composition containing no colorant compound (Comparative Example 1-C-1) also was prepared for evaluation. The amount of each REACTINT dye (Reactants I-IV) or colorant solution in toluene that was utilized is listed in Table 1. The column titled “colorant concentration” refers to the concentration of the dye in toluene that was added, wherein the Reactint dyes are listed as 100% since no solvents were added. The concentration of the colorant in the cured coating was 1 weight percent based upon 100% solids.

TABLE 1

| Coating | Colorant Compound | | | |
|---|---|---|---|---|
| Composition | in Coating | Colorant | Weight | |
| Example No. | Composition | Concentration | Added | |
| C-1 | None | 0% | 0 | g |
| 5 | Example 1 | 28% | 0.72 | g |
| 6 | Example 2 | 32% | 0.64 | g |
| 7 | Example 3 | 37.5% | 0.53 | g |
| 8 | Example 4 | 10.5% | 1.96 | g |
| C-2 | Reactant IV | 100% | 0.2 | g |
| C-3 | Reactant III | 100% | 0.2 | g |
| C-4 | Reactant II | 100% | 0.2 | g |
| C-5 | Reactant I | 100% | 0.2 | g |

The coating compositions of Examples 5-8 and Comparative Examples 1-5 were applied to 10.2 cm×10.2 cm (4 inch×4 inch) glass plates, 10.2 cm×10.2 cm (4 inch×4 inch) copolyester plaques (Spectar®, Eastman Chemical Company) and 7.6 cm×15.2 cm (3 inch×6 inch) aluminum. Each coating composition was drawn down with a wire wound rod to provide a 4-10 micron thick wet coating on the substrate. The coated substrates were passed through a UV cure machine at a speed of 7.3 meters per minute (24 feet/minute) using a lamp with an intensity of 118.1 watts per cm (300 watts per inch). Konig Pendulum Hardness measurements (ASTM D4366 DIN 1522) were determined twice for each of the cured coating (Table 2). Chemical resistance was tested by methyl ethyl ketone (MEK) double rubs.

TABLE 2

| | |
|---|---|
| Coating | Konig Pendulum |
| Composition | Hardness Measurements |

| Example No. | Substrate | Test 1 | Test 2 |
|---|---|---|---|
| C-1 | Aluminum | 235 | 236 |
| C-1 | Glass | 121 | 124 |
| C-1 | Copolyester | 233 | 236 |
| 5 | Aluminum | 236 | 240 |
| 5 | Glass | 182 | 183 |
| 5 | Copolyester | 236 | 234 |
| 6 | Aluminum | 240 | 245 |
| 6 | Glass | 207 | 215 |
| 6 | Copolyester | 237 | 238 |
| 7 | Aluminum | 245 | 246 |
| 7 | Glass | 110 | 112 |
| 7 | Copolyester | 242 | 239 |
| 8 | Aluminum | 243 | 240 |
| 8 | Glass | 164 | 180 |
| 8 | Copolyester | 238 | 239 |
| C-2 | Aluminum | 240 | 239 |
| C-2 | Glass | 191 | 195 |
| C-2 | Copolyester | 239 | 239 |
| C-3 | Aluminum | 249 | 243 |
| C-3 | Glass | 194 | 203 |
| C-3 | Copolyester | 245 | 243 |
| C-4 | Aluminum | 243 | 246 |
| C-4 | Glass | 209 | 209 |
| C-4 | Copolyester | 246 | 247 |
| C-5 | Aluminum | 243 | 237 |
| C-5 | Glass | 168 | 185 |
| C-5 | Copolyester | 241 | 243 |

The photopolymerizable coating compositions of Examples 9-12 and Comparative Examples 6-9 were prepared by mixing the following ingredients while heating using a heat gun to about 60° C. until the color was uniform.
4.0 g polyester acrylate (Jägalux UV1500, Jäger);
8.0 g bisphenol A epoxy acrylate (Sartomer CN-104, Sartomer Company, Lot: E628);
3.6 g dipropyleneglycol diacrylate (DPGDA, Surface Specialties UCB);
3.2 g trimethylolpropane triacrylate (TMPTA-N, Surface Specialties UCB);
1.0 g photoinitiator (Darocurel 173, Ciba Specialty Chemicals Inc., Lot: DC02442R); and
varying amounts of one of the colorant compounds produced in Examples 2-4 or Reactants II-IV.

The amount of each REACTINT dye (Reactant II-IV) or colorant solution in toluene utilized is listed in Table 3 wherein “Colorant Concentration” refers to the concentration of the colorant in toluene that was added. The REACTINT colorants are listed as 100% since no solvents were added. “Coating Colorant Concentration” refers to the weight percent of colorant contained in the cured coating based upon 100 weight percent solids.

TABLE 3

| | Colorant | | | | Coating |
|---|---|---|---|---|---|
| Coating | Compound | Colorant | | | Colorant |
| Composition | in Coating | Concen- | Weight | | Concen- |
| Example No. | Composition | tration | Added | | tration |
| 9 | Example 2 | 32% | 3.78 | g | 5.8 |
| 10 | Example 3 | 37.5% | 3.18 | g | 5.7 |
| 11 | Example 4 | 10.5% | 11.76 | g | 5.8 |
| C-6 | Reactant IV | 100% | 1.2 | g | 5.7 |
| C-7 | Reactant III | 100% | 1.2 | g | 5.7 |
| C-8 | Reactant II | 100% | 1.2 | g | 5.7 |
| 12 | Example 2 | 32% | 12.6 | g | 16.9 |
| C-9 | Reactant II | 100% | 3.62 | g | 15.4 |

The coating compositions of Examples 9-12 and Comparative Examples 6-9 were applied to 10.2 cm×10.2 cm (4 inch×4 inch) glass plates. Each coating composition was drawn down with a wire wound rod to provide a 4-10 micron thick wet coating on the glass substrate. The coated glass plates were passed through a UV cure machine at a speed of 7.3 meters per minute (24 feet/minute) using a lamp with an intensity of 118.1 watts per cm (300 watts per inch). Konig Pendulum Hardness measurements (ASTM D4366 DIN 1522) were determined twice for each of the cured coating (Test 1 and Test 2 in Table 4). Chemical resistance was tested by MEK double rubs.

TABLE 4

| | |
|---|---|
| Coating | Komig Pendulum |
| Composition | Hardness Measurements |

| Example No. | Trial 1 | Trial 2 |
|---|---|---|
| 9 | 163 | 170 |
| 10 | 181 | 183 |
| 11 | 225 | 228 |
| C-6 | 218 | 218 |
| C-7 | 190 | 197 |
| C-8 | 139 | 133 |
| 12 | 170 | 176 |
| C-9 | 106 | 106 |

The Konig pendulum hardness measurement data presented in Tables 2 and 4 reveal no significant difference between the hardness of the coatings prepared from coating compositions that contain either the colorant compounds produced in Examples 1-4 or Reactants I-IV. Neither the colorant compounds produced in Examples 1-4 nor Reactants I-IV extracted at concentration up to about 6% during 300 MEK double rubs.

The Konig pendulum hardness measurement data presented in Table 4 show a large difference between the hardness of the coating prepared from the coating composition of Comparative Examples 9 (containing 15.4% Reactant II) compared to the coating prepared from the coating composition of Example 12 (containing 16.9% of the colorant of Example 2). The coating containing the colorant of Exampe 2 of the present invention was harder. Reactant II present at a concentration of 15.4% extracted from the coating prepared from the coating composition of Comparative Examples 9 during the MEK rub test. Additionally, the coating became soft and peeled from the substrate during the MEK rub test. The colorant compounds of the present ivention did not extract from the coating composition of Examples 12 after 300 MEK double rubs and the coating remained visually unchanged. The data presented herein establish that the novel colorant compounds can be added to free-radical initiated coating formulations at high levels to give colored coating compositions wherein the color cannot be removed by solvent extraction and the hardness of the colored coating is not compromised.

The invention has been described in detail with particular reference to preferred embodiments thereof, but it will be understood that variations and modifications can be effected within the spirit and scope of the invention.

We claim:

1. Colorant compounds having formulas I-VI: 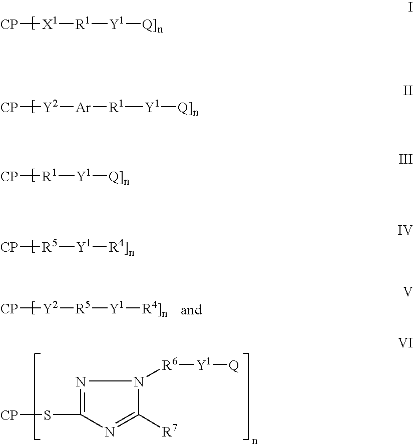
wherein
CP is a mono-, di-, tri- or tetravalent chromophore;
R₁ is —O—(CH₂CH(R²)O—)ₘ—CH₂CH(R²)—, —N(R³)—(CH₂CH(R²)O—)ₘ—CH₂CH(R²)— or —N[(CH₂CH(R²)O—)ₘ—CH₂CH(R²)—]₂;
R² is hydrogen or C₁-C₆ alkyl
R³ is hydrogen, C₁-C₆-alkyl, aryl or C₃-C₈-cycloalkyl;
R⁴ is —(CH₂CH(R²)O—)ₘ-Q;
R⁵ is C₁-C₆-alkylene, C₁-C₆-alkylene-arylene, cyclohexylene, arylene, C₁-C₆-alkylene-cyclohexylene or C₁-C₆-alkylene-cyclohexylene-C₁-C₆-alkylene;
R⁶ is —(CH₂CH(R²)O—)ₘ—CH₂CH₂—;
R⁷ is hydrogen, C₁-C₆-alkyl, aryl or C₃-C₈-cycloalkyl;
X₁ is —CO—, —SO₂— or arylene;
Y¹ is —O—, —N(R³)—, —N(R⁴)— or —S—;
Y² is —O—, —S—, —SO₂— or —N(R³)— or —N(R⁴)—;
Ar is arylene;
m is 4 to 100;
n is 1 to 4; and
Q is a photopolymerizable group selected from an organic radical having formulae: 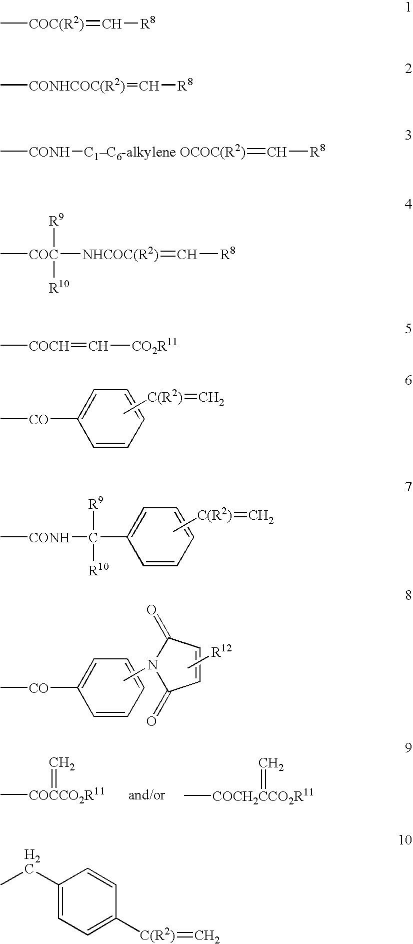
wherein
R² is hydrogen or C₁-C₆-alkyl;
R⁸ is hydrogen; C₁-C₆-alkyl; phenyl; phenyl substituted with one or more groups selected from C₁-C₆-alkyl, C₁-C₆-alkoxy, —N(C₁-C₆-alkyl)₂, nitro, cyano, C₂-C₆-alkoxycarbonyl, C₂-C₆-alkanoyloxy and halogen; 1- or 2-naphthyl; 1- or 2-naphthyl substituted with C₁-C₆-alkyl or C₁-C₆-alkoxy; 2- or 3-thienyl; 2- or 3-thienyl substituted with C₁-C₆-alkyl or halogen; 2- or 3-furyl; or 2- or 3-furyl substituted with C₁-C₆-alkyl;
R⁹ and R¹⁰ individually are the same or different and are hydrogen, C₁-C₆-alkyl, aryl; or in combination R⁹ and R¹⁰ represent a divalent -(—CH₂—)₃₋₅-radical;
R¹¹ is hydrogen, C₁-C₆-alkyl, C₃-C₈-alkenyl, C₃-C₈-cycloalkyl or aryl; and
R¹² is hydrogen, C₁-C₆-alkyl or aryl.

2. A colorant compound according to claim 1 having the formula
CP [symbol] X¹—R¹—Y¹-Q]ₙ
wherein
CP is a mono- or di-valent chromophore selected from anthraquinone, anthrapyridone (3H-dibenz-[f,ij]-isoquinoline-2,7-dione, anthrapyrimidine (7H-dibenz-[f,ij]-isoquinoline-7-one), anthrapyrimidine (7H-benzo[e]-perimidine-7-one) and anthrapyrimidone chromphores;
R¹ is —O—(CH₂CH(R²)O—)ₘ—CH₂CH(R²)—, —N(R³)—(CH₂CH(R²)O—)ₘ—CH₂CH(R²)— or —N[(CH₂CH(R²)O—)ₘ—CH₂CH(R²)—]₂;
R² is hydrogen or C₁-C₆ alkyl;
R³ is hydrogen, C₁-C₆-alkyl, aryl or C₃-C₈-cycloalkyl;
R⁴ is —(CH₂CH(R²)O—)ₘ-Q;
X¹ is —CO—, —SO₂— or arylene;
Y¹ is —O—, —N(R³)—, —N(R⁴)— or —S—;
m is 4 to 100;
n is 1 or 2; and
Q is a photopolymerizable group having the formula —COC(R³)═CH₂ or 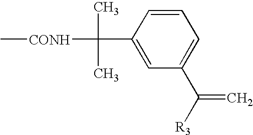
wherein R³ is hydrogen or methyl.

3. A colorant compound according to claim 1 having the formula
CP [symbol] Y²—Ar—R¹—Y¹-Q]ₙ
wherein
CP is a mono- or di-valent chromophore selected from isothiazoloanthrone, methine, bis-methine and coumarin (2-H-1-benzopyran-2-one) chromphores;
R¹ is —O—(CH₂CH(R²)O—)ₘ—CH₂CH(R²)—, —N(R³)—(CH₂CH(R²)O—)ₘ—CH₂CH(R²)— or —N[(CH₂CH(R²)O—)ₘ—CH₂CH(R²)—]₂;
R² is hydrogen or C₁-C₆ alkyl;
R³ is hydrogen, C₁-C₆-alkyl, aryl or C₃-C₈-cycloalkyl;
R⁴ is —(CH₂CH(R²)O—)ₘ-Q;
Y¹ is —O—, —N(R³)—, —N(R⁴)— or —S—;
Y² is —O—, —S—, —SO₂— or —N(R³)— or —N(R⁴)—;
Ar is arylene;
m is 4 to 100;
n is 1 or 2; and
Q is a photopolymerizable group having the formula —COC(R³)═CH₂ or 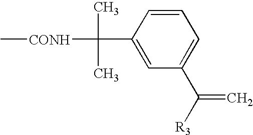
wherein R³ is hydrogen or methyl.

4. A colorant compound according to claim 1 having the formula
CP [symbol] R¹—Y¹-Q]ₙ
wherein
CP is a mono- or di-valent chromophore selected from 3-aryl-2,5-dioxypyrroline, 3-aryl-5-dicyanomethylene-2-oxypyrroline, perinone and quinophthalone chromphores;
R¹ is —O—(CH₂CH(R²)O—)ₘ—CH₂CH(R²)—, —N(R³)—(CH₂CH(R²)O—)ₘ—CH₂CH(R²)— or —N[(CH₂CH(R²)O—)ₘ—CH₂CH(R²)—]₂;
R² is hydrogen or C₁-C₆ alkyl;
R³ is hydrogen, C₁-C₆-alkyl, aryl or C₃-C₈-cycloalkyl;
R⁴ is —(CH₂CH(R²)O—)ₘ-Q;
Y¹ is —O—, —N(R³)—, —N(R⁴)— or —S—;
m is 4 to 100;
n is 1 or 2; and
Q is a photopolymerizable group having the formula —COC(R³)═CH₂ or 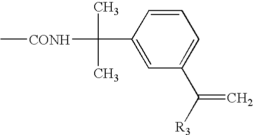
wherein R³ is hydrogen or methyl.

5. A colorant compound according to claim 1 having the formula
CP [symbol] R⁵—Y¹—R⁴]ₙ
wherein
CP is a mono- or di-valent chromophore selected from phthalocyanine, metal phthalocyanine, indanthrone and pyrylium chromphores;
R² is hydrogen or C₁-C₆ alkyl;
R³ is hydrogen, C₁-C₆-alkyl, aryl or C₃-C₈-cycloalkyl;
R⁴ is —(CH₂CH(R²)O—)ₘ-Q;
R⁵ is C₁-C₆-alkylene, C₁-C₆-alkylene-arylene, cyclohexylene, arylene, C₁-C₆-alkylene-cyclohexylene or C₁-C₆-alkylene-cyclohexylene-C₁-C₆-alkylene;
Y¹ is —O—, —N(R³)—, —N(R⁴)— or —S—;
m is 4 to 100;
n is 1 or 2; and
Q is a photopolymerizable group having the formula —COC(R³)═CH₂ or 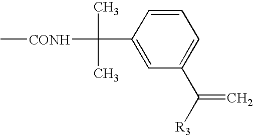
wherein R³ is hydrogen or methyl.

6. A colorant compound according to claim 1 having the formula
CP [symbol] Y²—R⁵—Y¹—R⁴]ₙ
wherein
CP is a mono- or di-valent chromophore selected from nitroarylamine and 2,5-diarylaminoterephthalic ester chromphores;
R² is hydrogen or C₁-C₆ alkyl
R³ is hydrogen, C₁-C₆-alkyl, aryl or C₃-C₈-cycloalkyl;
R⁴ is —(CH₂CH(R²)O—)ₘ-Q;
R⁵ is C₁-C₆-alkylene, C₁-C₆-alkylene-arylene, cyclohexylene, arylene, C₁-C₆-alkylene-cyclohexylene or C₁-C₆-alkylene-cyclohexylene-C₁-C₆-alkylene;
Y¹ is —O—, —N(R³)—, —N(R⁴)— or —S—;
Y² is —O—, —S—, —SO₂— or —N(R³)— or —N(R⁴)—;
m is 4 to 100;
n is 1 or 2; and
Q is a photopolymerizable group having the formula —COC(R³)═CH₂ or 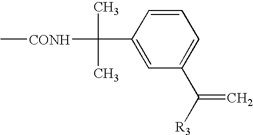
wherein R³ is hydrogen or methyl.

7. A colorant compound according to claim 1 having the formula 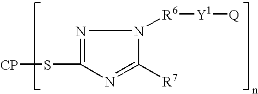
wherein
CP is a mono- or di-valent chromophore selected from azo and bis-azo chromphores;
R² is hydrogen or C₁-C₆ alkyl
R³ is hydrogen, C₁-C₆-alkyl, aryl or C₃-C₈-cycloalkyl;
R⁴ is —(CH₂CH(R²)O—)ₘ-Q;
R⁶ is —(CH₂CH(R²)O—)ₘ—CH₂CH₂—;
R⁷ is hydrogen, C₁-C₆-alkyl, aryl or C₃-C₈-cycloalkyl;
Y¹ is —O—, —N(R³)—, —N(R⁴)— or —S—;
Y² is —O—, —S—, —SO₂— or —N(R³)— or —N(R⁴)—;
m is 4 to 100;
n is 1 or 2; and
Q is a photopolymerizable group having the formula —COC(R³)═CH₂ or 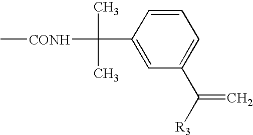
wherein R³ is hydrogen or methyl.

8. A coating composition comprising (i) one or more polymerizable vinyl compounds, (ii) one or more of the colorant compounds defined in claim 1, and (iii) a photoinitiator.

9. A coating composition comprising (i) one or more polymerizable vinyl compounds, (ii) one or more of the colorant compounds defined in claim 1 present in a concentration of about 0.05 to 15 weight percent based on the weight of component (i), and (iii) a photoinitiator present in a concentration of about 1 to 15 weight percent based on the weight of component (i).

10. A coating composition according to claim 9 wherein the polymerizable vinyl compounds comprise a solution of a polymeric, polymerizable vinyl compound selected from acrylated and methacrylated polyesters, acrylated and methacrylated polyethers, acrylated and methacrylated epoxy polymers, acrylated and methacrylated urethanes, and mixtures thereof, in a diluent selected from monomeric acrylate and methacrylate esters.

11. A polymeric coating composition comprising a polymer of one or more acrylic acid esters, one or more methacrylic acid esters, styrenes and/or other copolymerizable vinyl compounds, having copolymerized therein one or more of the colorant compounds defined in claim 1.

12. A polymeric coating composition comprising a polymer of one or more acrylic acid esters, one or more methacrylic acid esters, or a mixture thereof having copolymerized therein one or more of the colorant compounds defined in claim 1.

13. An article coated with a polymeric composition comprising a polymer of one or more acrylic acid esters, one or more methacrylic acid esters, styrenes and/or other polymerizable vinyl compounds, having copolymerized therein one or more of the colorant compounds defined in claim 1.

14. A coated metal, glass, wood, paper, leather, or thermoplastics article coated with a polymeric composition comprising a polymer of of one or more acrylic acid esters, one or more methacrylic acid esters, or a mixture thereof having copolymerized therein one or more of the colorant compounds defined in claim 1.
